(19) United States
(12) Patent Application Publication
(10) Pub. No.: US 2016/0105357 A1
(43) Pub. Date: Apr. 14, 2016

(54) METHOD AND NETWORK APPARATUS OF ESTABLISHING PATH

(71) Applicant: HUAWEI TECHNOLOGIES CO., LTD., Shenzhen (CN)

(72) Inventors: Keshava A. K, Bangalore (IN); Dhruv DHODY, Bangalore (IN)

(73) Assignee: HUAWEI TECHNOLOGIES CO., LTD., Shenzhen (CN)

(21) Appl. No.: 14/973,959

(22) Filed: Dec. 18, 2015

Related U.S. Application Data
(63) Continuation of application No. PCT/CN2014/080407, filed on Jun. 20, 2014.

(30) Foreign Application Priority Data
Jun. 20, 2013 (IN) IN2681/CHE/2013

(51) Int. Cl. H04L 12/717; H04L 12/755

(52) U.S. Cl. CPC H04L 45/42; H04L 45/021

(57) ABSTRACT

Embodiments of the present application provide a method and network apparatus of establishing path, applied in a SDN, the method includes: receiving, by a node, forwarding information from a SDNC; wherein the forwarding information is generated based on a relationship between prefix of IP address and tunnel information; receiving a packet, wherein the packet comprises first prefix information of a first IP address; forwarding the packet according to first tunnel information corresponding to the first prefix information of the first IP address. In the application, the process of route calculation is simplified, and number of forwarding flow entry in internal nodes is reduced.

### CROSS-REFERENCE TO RELATED APPLICATIONS

This application is a continuation of International Application No. PCT/CN2014/080407, filed on Jun. 20, 2014, which claims priority to Indian Patent Application No. IN2681/CHE/2013, filed on Jun. 20, 2013, both of which are hereby incorporated by reference in their entirety.

### TECHNICAL FIELD

This application relates to the SDN (Software Defined Network) technology and in particular, to a method and network apparatus of establishing path.

### BACKGROUND

The SDNC (Software Defined Network Controller) is a new concept in the networking industry. Existing individual protocol functions (such as topology discovery, traffic engineering, best path and route selection etc.) in each of the network elements will be removed, and these functions will be maintained in a SDNC, which is a centrally entity independent of hardware.

FIG. 1 is a topology showing SDNC in the related art. As shown in FIG. 1, the SDNC will control the open-flow enabled switch. The switches communicate with the SDNC and the SDNC manages the switches via the OpenFlow protocol.

A switch may consist of one or more flow tables and a group table. Using the OpenFlow protocol, the SDNC may add, update and delete flow entries in flow tables both reactively and proactively.

However, the applicant found that: for a global prefix, SDNC needs to set flow for each of nodes in the network, such that number of forwarding instructions will increase as number of global prefix increases, and the amount of flow based calculation increases in SDNC as number of nodes increase.

Furthermore, all the nodes in the SDN should be aware of external prefix to provide the global connectivity, and the process of route calculation is complex.

### SUMMARY

Embodiments of the present application pertain to a method and network apparatus of establishing path. The objects of the application are to simplify the process of route calculation, and reduce number of forwarding flow entry in some nodes.

According to a first aspect of the embodiments of the present application, a method of establishing path is provided, applied in a SDN (Software Defined Network), includes:
receiving, by an node, forwarding information from a SDN controller (SDNC); wherein the forwarding information is generated based on a relationship between a prefix of an IP address and tunnel information;
receiving, by the node, a packet, wherein the packet comprises first prefix information of a first IP address;
forwarding, by the node, the packet according to first tunnel information corresponding to the first prefix information of the first IP address.

According to another aspect of the embodiments of the present application, wherein the first tunnel information comprises at least one of: a next-hop IP address and a destination IP address.

According to another aspect of the embodiments of the present application, wherein the first prefix information of the first IP address is in a prefix table and the first tunnel information is in a tunnel table.

According to a second aspect of the embodiments of the present application, a method of establishing path is provided and applied in a SDN (Software Defined Network), the method comprises:
establishing, by a SDN controller (SDNC), relationship between a prefix of an IP address and tunnel information;
generating, by the SDNC, forwarding information based on the relationship;
sending, by the SDNC, forwarding information to one or more nodes so that the one or more nodes forward packets according to the forwarding information.

According to another aspect of the embodiments of the present application, wherein the method further comprises:
acquiring, by the SDNC, a first prefix of a first IP address and first tunnel information;
storing, by the SDNC, the first prefix of the first IP address in a prefix table and the first tunnel information in a tunnel table.

According to another aspect of the embodiments of the present application, wherein the first tunnel information comprises at least one of: a next-hop IP address and a destination IP address.

According to another aspect of the embodiments of the present application, wherein the one or more nodes have full mesh tunnel to other nodes in the SDNC.

According to a third aspect of the embodiments of the present application, a node is provided, where the node comprises:
a first receiving unit, configured to receive forwarding information from a Software Defined Network Controller (SDNC); wherein the forwarding information is generated based on a relationship between a prefix of an IP address and tunnel information;
a second receiving unit, configured to receive a packet, wherein the packet comprises a first prefix information of a first IP address;
a forwarding unit, configured to forward the packet according to first tunnel information corresponding to the first prefix information of the first IP address.

According to a fourth aspect of the embodiments of the present application, a Software Defined Network controller (SDNC) is provided, and the SDNC comprises:
an establishing unit, configured to establish a relationship between a prefix of an IP address and tunnel information;
a generating unit, configured to generate forwarding information based on the relationship;
a sending unit, configured to send forwarding information to one or more nodes so that the one or more nodes forward packets according to the forwarding information.

According to another aspect of the embodiments of the present application, wherein the SDNC further comprises:
an acquiring unit, configured to acquire a first prefix of a first IP address and first tunnel information;
a storing unit, configured to store the first prefix of the first IP in a prefix table and store the first tunnel information in a tunnel table.

The advantages of the present application exist in that: a relationship between a prefix of an IP address and tunnel information is established by a SDNC; so that the process of route calculation is simplified, and number of forwarding flow entry in internal nodes is reduced.

These and further aspects and features of the present application will be apparent with reference to the following description and attached drawings. In the description and drawings, particular embodiments of the application have been disclosed in detail as being indicative of some of the ways in which the principles of the application may be employed, but it is understood that the application is not limited correspondingly in scope. Rather, the application includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the application may be better understood with reference to the following drawings. The components in the drawings are not necessarily to scale, emphasis instead being placed upon clearly illustrating the principles of the present application. To facilitate illustrating and describing some parts of the application, corresponding portions of the drawings may be exaggerated in size, e.g., made larger in relation to other parts than in an exemplary device actually made according to the application. Elements and features depicted in one drawing or embodiment of the application may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The drawings are included to provide further understanding of the present application, which constitute a part of the specification and illustrate the embodiments of the present application, and are used for setting forth the principles of the present application together with the description. The same element is represented with the same reference number throughout the drawings.

In the drawings:

FIG. 1 is a topology showing SDNC in the related art;

FIG. 2 is a topology showing the process of forwarding a packet in the related art;

FIG. 3 is a flowchart of the method of establishing path in accordance with an embodiment of the present application;

FIG. 4 is a topology showing the process of forwarding a packet in the present application;

FIG. 5 is a flowchart of the method of establishing path in accordance with an embodiment of the present application;

FIG. 6 is an example of tunnel in accordance with an embodiment of the present application;

FIG. 7 is an example of SDNC in accordance with an embodiment of the present application;

FIG. 8 is an example of relationship in accordance with an embodiment of the present application;

FIG. 9 is a flowchart of the method of establishing path in accordance with an embodiment of the present application;

FIG. 10 is a schematic diagram of the network apparatus in accordance with an embodiment of the present application;

FIG. 11 is another schematic diagram of the network apparatus in accordance with an embodiment of the present application;

FIG. 12 is a schematic diagram of the network apparatus in accordance with an embodiment of the present application;

FIG. 13 is a schematic block diagram showing the systematic structure of the network apparatus of the embodiments of the present application.

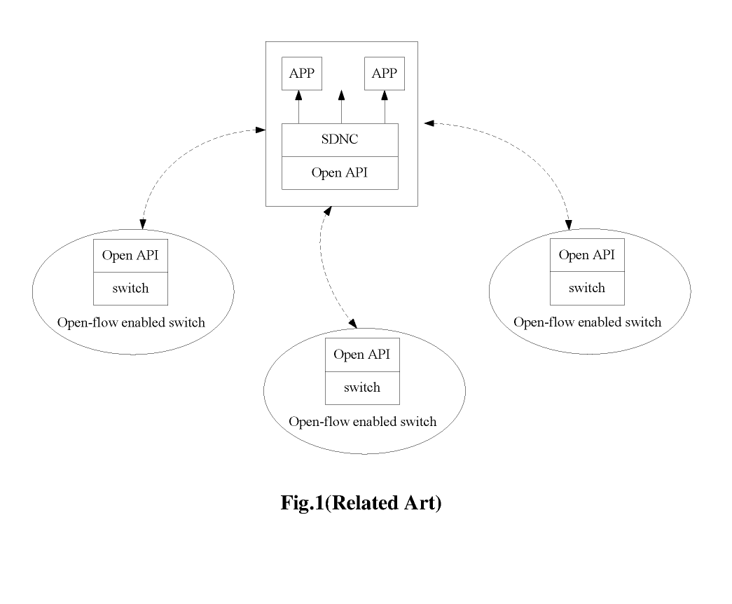

### DETAILED DESCRIPTION OF EMBODIMENTS

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

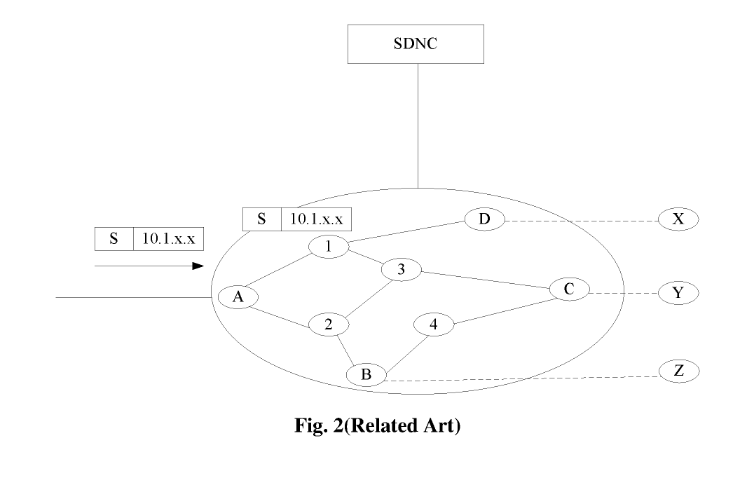

FIG. 2 is a topology showing the process of forwarding a packet in the related art. As shown in FIG. 2, there are some types of nodes: nodes (may be called edge node, such as A, B, C, D) at the edge of a SDNC administration, nodes (may be called internal nodes, such as 1, 2, 3, 4) inside edge of the SDNC administration, nodes (may be called external nodes, such as X, Y, Z) outside of the SDNC administration.

As shown in FIG. 2, when a packet (which includes a global prefix, such as 10.1.xx) is received by the edge node A, the edge node A will forward the packet to an internal node 1, based on the forwarding information downloaded from the SDNC. At the same way, the internal node 1 will forward the packet based on the forwarding information downloaded from the SDNC.

That is to say, the SDNC need to set the flow for each node (edge nodes and internal nodes). So that all the nodes in the SDN should be aware of an external prefix to provide the global connectivity, and the process of route calculation is complex. Furthermore, number of forwarding instructions will increase as number of global prefix increases, and the amount of flow based calculation increases in SDNC as number of nodes increase.

In the application, the forwarding (data path) and the high level routing decisions (control path) are separated. The data path portion still resides on the internal node, while high level routing decisions are moved to the SDNC. The data path of an internal node presents a clean flow table abstraction, so that the internal node will be unaware of global prefix forwarding. The embodiments of the present application are described as follows in reference to the drawings.

### EMBODIMENT 1

An embodiment of the present application provides a method of establishing path, applied in a SDNC (Software Defined Network Controller) side of a Software Defined Network.

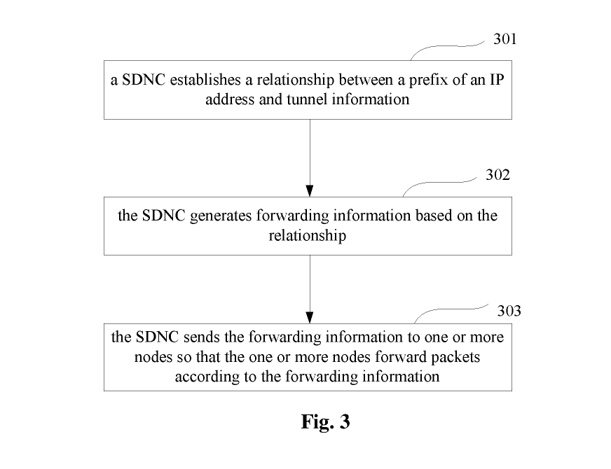

FIG. 3 is a flowchart of the method of establishing path in accordance with an embodiment of the present application. As shown in FIG. 3, the method includes:

Block 301, a SDNC establishes relationship between a prefix of an IP address and tunnel information;

Block 302, the SDNC generates forwarding information based on the relationship;

Block 303, the SDNC sends the forwarding information to one or more nodes so that the one or more nodes forward packets according to the forwarding information.

In the embodiment, the one or more nodes are in the scope of the SDNC administration. The SDNC may use the following tables: a global prefix table for every external IP prefix, a tunnel table for maintaining information of all full mesh tunnels.

In the embodiment, edge nodes and internal nodes are separated in SDNC domain. The SDNC may establish a relationship between a prefix and a tunnel, such that the internal nodes will do only flow-based forwarding.

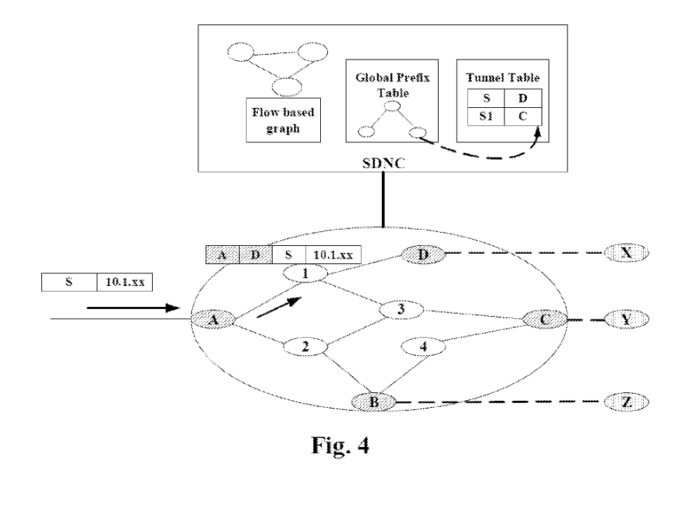

FIG. 4 is a topology showing the process of forwarding a packet in the present application. As shown in FIG. 4, there are some types of nodes: nodes (may be called edge node, such as A, B, C, D) at the edge of a SDNC administration, nodes (may be called internal nodes, such as 1, 2, 3, 4) inside edge of the SDNC administration, nodes (may be called external nodes, such as X, Y, Z) outside of the SDNC administration.

As shown in FIG. 4, the SDNC at least has two tables: a global prefix table and a tunnel table. Furthermore, the SDNC may establish the relationship between a prefix and a tunnel, such as: 10.1.xx corresponds to A->D. Nodes will download forwarding information which is generated based on the relationship.

As shown in FIG. 4, when a packet (which includes a global prefix, such as 10.1.xx) is received by the edge node A, the edge node A will forward the packet based on the forwarding information downloaded from the SDNC. Since the forwarding information has included the relationship, the process of finding “prefix to tunnel relation” is simplified, so that complex traditional route calculation is avoided.

As shown in FIG. 4, the forwarding information has included the relationship; internal node (such as node 1) will be unaware of global prefix when it forwards the packet. Number of forwarding flow entry in an internal node will be reduced, and overall route calculation related functionalities are reduced in a SDNC (since internal nodes only do flow-based forwarding). Furthermore, internal nodes are of less capacity, irrespective of large number of global routing entry in edge nodes.

It can be seen from the above embodiment that: a relationship between a prefix of an IP address and tunnel information is established by a SDNC; so that the process of route calculation is simplified, and number of forwarding flow entry in internal nodes is reduced.

### EMBODIMENT

The embodiment of the present application provides a method of establishing path, applied in a SDNC side. The embodiment is based on the embodiment 1 and the same content will not be described.

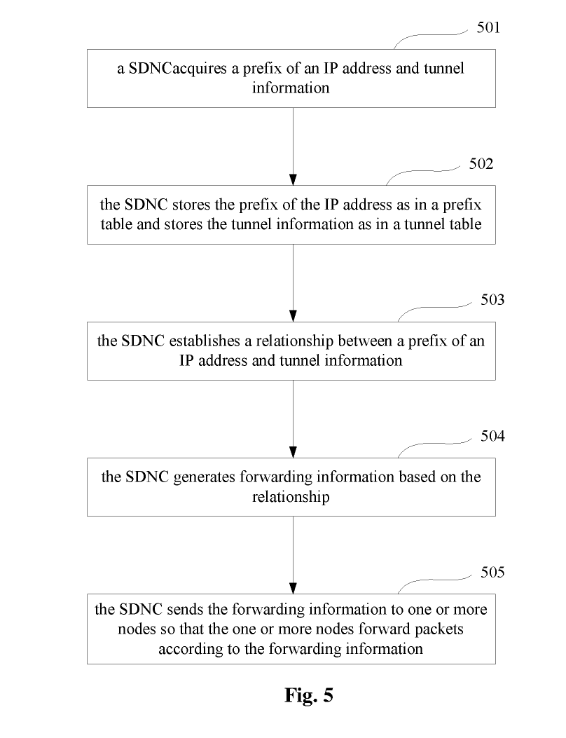

FIG. 5 is a flowchart of the method of establishing path in accordance with an embodiment of the present application, as shown in FIG. 5, the method includes:

Block 501, a SDNC acquires a prefix of an IP address and tunnel information;

Block 502, the SDNC stores the prefix of the IP address as in a prefix table and stores the tunnel information as in a tunnel table.

Block 503, the SDNC establishes a relationship between a prefix of an IP address and tunnel information;

Block 504, the SDNC generates forwarding information based on the relationship;

Block 505, the SDNC sends the forwarding information to one or more nodes so that the one or more nodes forward packets according to the forwarding information.

In the embodiment, in the SDNC, a full mesh of tunnels for all edge nodes to every other edge node needs to be established.

In implement, for IP GRE (Generic Routing Encapsulation) kind tunnel, earlier GRE forwarding was based on IP routing built by SPF (Shortest Path First). But in this application, it requires pre-calculated path to install in SDNC and download to each Nodes on that path. So the path calculation is generalized concept for both IP tunnel and MPLS (Multiprotocol Label Switching) tunnel.

In implement, SDNC may use algorithm like GCO (Global Concurrent Optimization) or CSPF (Constrained Shortest Path First) based mechanism. Where, GCO is to optimize the entire tunnels together. These algorithms may take care of link utilization, capacity etc.

And these algorithms use paths which optimize the whole SDN network. The path is calculated irrespective of the tunnel type IP/MPLS. In implement, tunnel forwarding instructions on these paths are downloaded on the nodes.

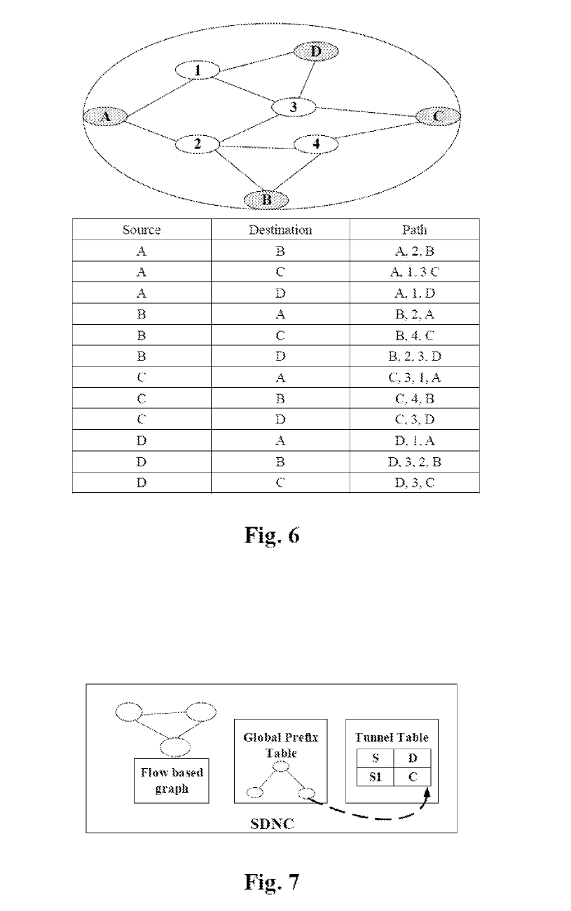

FIG. 6 is an example of tunnel in accordance with an embodiment of the present application. As shown in FIG. 6, for example, for tunnel to A to B, path is A->2->B.

In the embodiment, SDNC may acquire a first prefix of a first IP address and first tunnel information; and stores the first prefix of the first IP address in a prefix table and stores the first tunnel information in a tunnel table.

FIG. 7 is an example of a SDNC in accordance with an embodiment of the present application. As shown in FIG. 7, a “Global Prefix Table” and a “Tunnel Table” will be built in a SDNC. Learning of the global prefix may happen by any of the available routing mechanism, which is out of scope for the context.

As shown in FIG. 7, each prefix in “Global Prefix Table” will have ‘Prefix Source relation’ to ‘Tunnel Table’ based on its learning from this tunnel. These prefix are either configured on a SDNC or learned via a routing gateway (which maintain external routing relationship, such as EBGP (Exterior Border Gateway Protocol)) or some similar mechanism.

In implement, the relationship may be that: a prefix inside the prefix table has relation with a destination node inside the tunnel table. As for relationship between “Global Prefix Table” and “Tunnel Table”, a SDNC generates forwarding information based on the relationship.

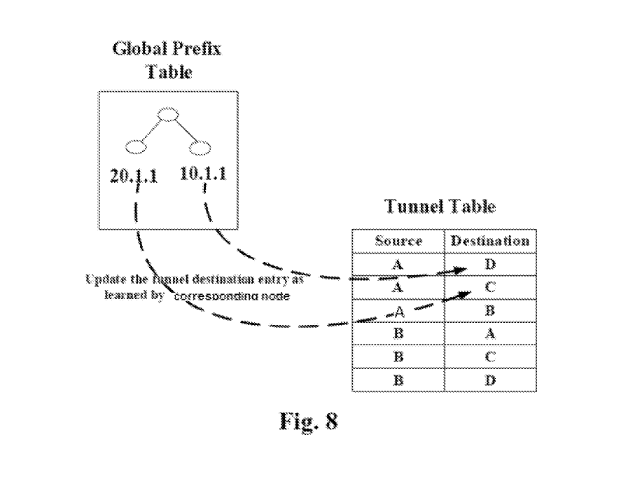

FIG. 8 is an example of relationship in accordance with an embodiment of the present application. As shown in FIG. 8, for example, prefix 10.1.1 is learned from D and 20.1.1 is learned from C.

In the embodiment, for each edge node, the edge node may download a tunnel forwarding instruction included the forwarding information (such as a flow entry) from the SDNC.

In implement, when downloading the flow entry in an internal node A, for prefix 10.1.1.1, the node A will use a tunnel A->D to forward a packet; for a prefix 20.1.1.1, the node A will use a tunnel A->C to forward a packet. When downloading the flow entry in an internal node B, for a prefix 10.1.1.1, the node B will use a tunnel B->D to forward a packet; for the prefix 20.1.1.1, the node B will use a tunnel B->C to forward a packet. So, this is a simple solution without any complex route calculation.

In the embodiment, for each internal node, SDNC will download the forwarding information to internal nodes to have tunnel establishment; this is independent of route prefix/routing.

It can be seen from the above embodiment that: a relationship between a prefix of an IP address and tunnel information is established by a SDNC; so that the process of route calculation is simplified, and number of forwarding flow entry in internal nodes is reduced.

### EMBODIMENT 3

The embodiment of the present application provides a method of establishing path, applied in a node (such as an edge node) side of a SDN. The embodiment corresponds to the method of the above embodiment 1 or 2, and the same content will not be described.

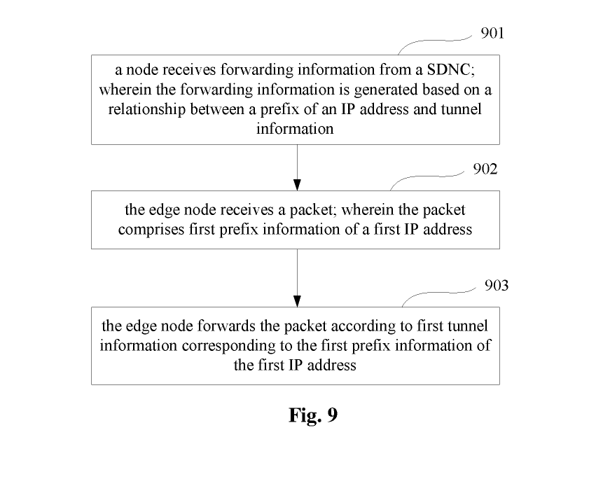

FIG. 9 is a flowchart of the method of establishing path in accordance with an embodiment of the present application, as shown in FIG. 9, the method includes:

Block 901, a node receives forwarding information from a SDNC; wherein the forwarding information is generated based on a relationship between a prefix of an IP address and tunnel information.

Block 902, the edge node receives a packet; wherein the packet comprises first prefix information of a first IP address.

Block 903, the edge node forwards the packet according to first tunnel information corresponding to the first prefix information of the first IP address.

In the embodiment, the first tunnel information may include at least one of: a next-hop IP address and a destination IP address.

In the embodiment, the first prefix of the first IP address may be in a prefix table; the first tunnel information may be in a tunnel table.

It can be seen from the above embodiment that: a relationship between a prefix of an IP address and tunnel information is established by SDNC; so that the process of route calculation is simplified, and number of forwarding flow entry in internal nodes is reduced.

### EMBODIMENT 4

The embodiment of the present application further provides a network apparatus, applied in a SDNC. The embodiment corresponds to the method of the above embodiment 1 or 2, and the same content will not be described.

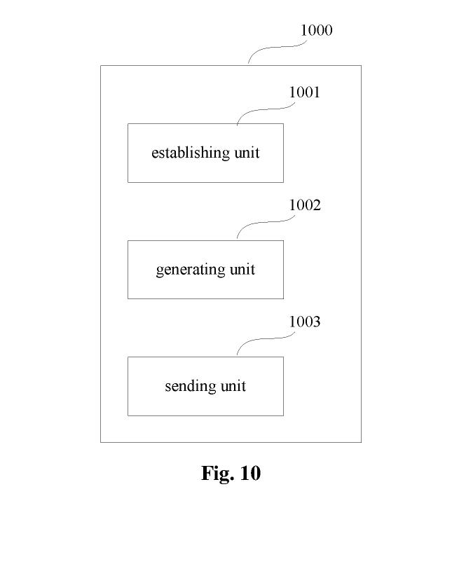

FIG. 10 is a schematic diagram of the SDNC in accordance with an embodiment of the present application. As shown in FIG. 10, the SDNC 1000 includes: an establishing unit 1001, a generating unit 1002 and a sending unit 1003.

In the embodiment, the function of provision tunnel may be integrated in the SDNC; other parts of the SDNC may refer to the existing technology and not be described in the present application. However, it is not limited thereto, and particular implement way may be determined as actually required.

Where, the establishing unit 1001 is configured to establish a relationship between a prefix of an IP address and tunnel information; the generating unit 1002 is configured to generate forwarding information based on the relationship; the sending unit 1003 is configured to send forwarding information to one or more nodes so that the one or more nodes forward a packet according to the forwarding information.

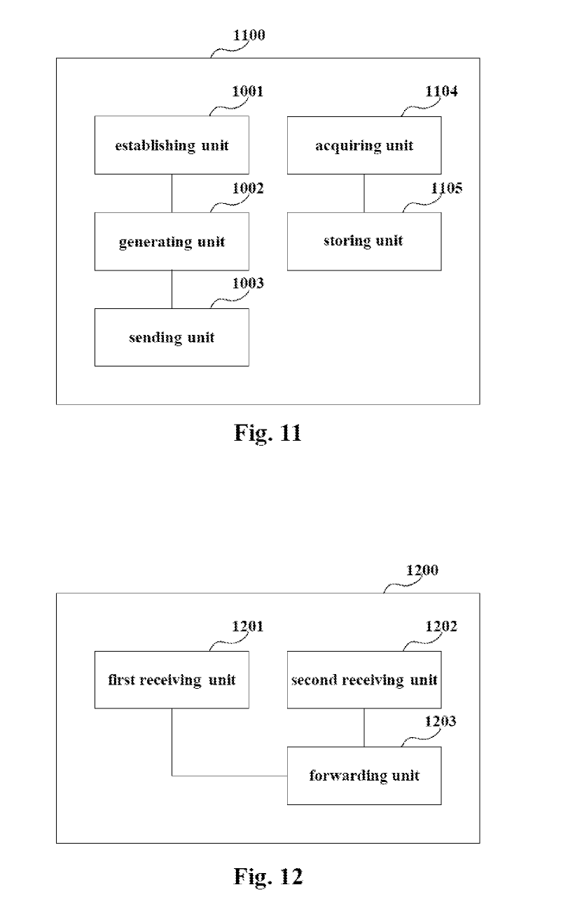

FIG. 11 is another schematic diagram of the network apparatus in accordance with an embodiment of the present application. As shown in FIG. 11, the SDNC 1100 includes: an establishing unit 1001, a generating unit 1002 and a sending unit 1003. As described in above.

As shown in FIG. 11, the SDNC 1100 may further include: an acquiring unit 1104 and a storing unit 1105. Where, the acquiring unit 1104 is configured to acquire the first prefix of the first IP address and first tunnel information; the storing unit 1105 is configured to store the first prefix of the first IP address in a prefix table and store the first tunnel information in a tunnel table.

It can be seen from the above embodiment that: relationship between a prefix of an IP address and tunnel information is established by SDNC; so that the process of route calculation is simplified, and number of forwarding flow entry in internal nodes is reduced.

### EMBODIMENT 5

The embodiment of the present application further provides a network apparatus, applied in a node. The embodiment corresponds to the method of the above embodiment 3, and the same content will not be described.

FIG. 12 is a schematic diagram of the network apparatus in accordance with an embodiment of the present application. As shown in FIG. 12, the node 1200 includes: a first receiving unit 1201, a second receiving unit 1202 and a forwarding unit 1203.

In the embodiment, the function of provision tunnel may be integrated in the node; other parts of the node may refer to the existing technology and not be described in the present application. However, it is not limited thereto, and particular implement way may be determined as actually required.

Where, the first receiving unit 1201 is configured to receive forwarding information from a SDNC; wherein the forwarding information is generated based on a relationship between a prefix of an IP address and tunnel information; the second receiving unit 1202 is configured to receive a packet, wherein the packet comprises first prefix information of a first IP address; the forwarding unit 1203 is configured to forward the packet according to first tunnel information corresponding to the first prefix information of the first IP address.

In the embodiment, the first tunnel information may include at least one of: a next-hop IP address or a destination IP address.

In the embodiment, the first prefix of the first IP address may be in a prefix table; the first tunnel information may be in a tunnel table.

It can be seen from the above embodiment that: relationship between a prefix of an IP address and tunnel information is established by a SDNC; so that the process of route calculation is simplified, and number of forwarding flow entry in internal nodes is reduced.

It should be understood that each of the parts of the present application may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

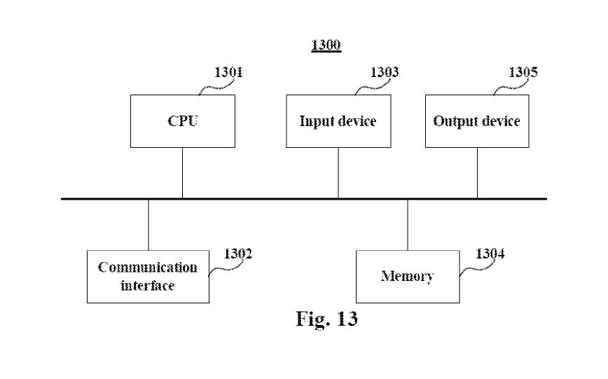

FIG. 13 is a schematic block diagram showing the systematic structure of the network apparatus of the embodiments of the present application. Such a figure is just exemplary and other types of structures may also be used for supplementing or replacing this structure, so as to implement the function of telecommunications or other functions.

As shown in FIG. 13, the network apparatus 1300 may include a CPU 1301, a communication interface 1302, an input device 1303, a memory 1304 and an output device 1305.

Where, the CPU 1301 (also referred to as a controller or an operational control, which may include a microprocessor or other processing devices and/or logic devices) receives input and controls each part and operation of the network apparatus. The input device 1303 provides input to the CPU 1301. The input device 1303 may be for example a key or touch input device. The output device 1305 receives the data from the CPU 1301 and sends it to other apparatus.

The memory 1304 is coupled to the CPU 1301. The memory 1304 may be a solid memory, such as a read-only memory (ROM), a random access memory (RAM), and a SIM card, etc., and may also be such a memory that stores information even when the power is interrupted, may be optionally erased and provided with more data. Examples of such a memory are sometimes referred to as an EPROM, etc. The memory 1304 may also be certain other types of devices.

The communication interface 1302 may be a transmitter/receiver which transmitting and receiving signals via an antenna. The communication interface 1302 (transmitter/receiver) is coupled to the CPU 1301 to provide input signals and receive output signals, this being similar to the case in a conventional communication center.

The description or blocks in the flowcharts or of any process or method in other manners may be understood as being indicative of comprising one or more modules, segments or parts for realizing the codes of executable instructions of the steps in specific logic functions or processes, and that the scope of the embodiments of the present application comprise other implementations, wherein the functions may be executed in manners different from those shown or discussed, including executing the functions according to the related functions in a substantially simultaneous manner or in a reverse order, which should be understood by those skilled in the art to which the present application pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present application. It should be understood that those skilled in the art may prepare appropriate computer codes to carry out each of the steps and processes as described above and shown in the drawings. It should be also understood that all the terminals, computers, servers, and networks may be any type, and the computer codes may be prepared according to the disclosure to carry out the present application by using the apparatus.

Particular embodiments of the present application have been disclosed herein. Those skilled in the art will readily recognize that the present application is applicable in other environments. In practice, there exist many embodiments and implementations. The appended claims are by no means intended to limit the scope of the present application to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular embodiment or embodiments have been shown and the present application has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present application with respect to structure. Furthermore, although the a particular feature of the present application is described with respect to only one or more of the illustrated embodiments, such a feature may be combined with one or more other features of other embodiments as desired and in consideration of advantageous aspects of any given or particular application.

We claim:

1. A method of establishing path, where the method is applied in a Software Defined Network (SDN), and the method comprises:
receiving, by a node, forwarding information from a SDN controller (SDNC); wherein the forwarding information is generated based on a relationship between a prefix of an IP address and tunnel information;
receiving, by the node, a packet, wherein the packet comprises first prefix information of a first IP address;
forwarding, by the node, the packet according to first tunnel information corresponding to the first prefix information of the first IP address.

2. The method of claim 1, wherein the first tunnel information comprises at least one of: a next-hop IP address and a destination IP address.

3. The method of claim 2, wherein the first prefix of the first IP address is in a prefix table and the first tunnel information is in a tunnel table.

4. A method of establishing path, where the method is applied in a Software Defined Network (SDN), and the method comprises:
establishing, by a SDN controller (SDNC), relationship between a prefix of an IP address and tunnel information;
generating, by the SDNC, forwarding information based on the relationship;
sending, by the SDNC, forwarding information to one or more nodes so that the one or more nodes forward packets according to the forwarding information.

5. The method of claim 4, wherein the method further comprises:
acquiring, by the SDNC, a first prefix of a first IP address and first tunnel information;
storing, by the SDNC, the first prefix of the first IP address in a prefix table and the first tunnel information in a tunnel table.

6. The method of claim 5, wherein the first tunnel information comprises at least one of: a next-hop IP address and a destination IP address.

7. The method of claim 4, wherein the one or more nodes have full mesh tunnel to other nodes in the SDNC.

8. A node, comprising:
a first receiving unit, configured to receive forwarding information from a Software Defined Network Controller (SDNC); wherein the forwarding information is generated based on a relationship between a prefix of an IP address and tunnel information;
a second receiving unit, configured to receive a packet, wherein the packet comprises first prefix information of a first IP address;
a forwarding unit, configured to forward the packet according to first tunnel information corresponding to the first prefix information of the first IP address.

9. The node of claim 8, wherein the first tunnel information comprises at least one of: a next-hop IP address and a destination IP address.

10. The node of claim 9, wherein the first prefix of the first IP address is in a prefix table and the first tunnel information is in a tunnel table.

11. A Software Defined Network controller (SDNC), comprising:
an establishing unit, configured to establish a relationship between a prefix of an IP address and tunnel information;
a generating unit, configured to generate forwarding information based on the relationship;
a sending unit, configured to send forwarding information to one or more nodes so that the one or more nodes forward packet according to the forwarding information.

12. The SDNC of claim 11, further comprising:
an acquiring unit, configured to acquire a first prefix of a first IP address and first tunnel information;
a storing unit, configured to store the first prefix of the first IP address in a prefix table and store the first tunnel information in a tunnel table.

13. The SDNC of claim 11, wherein the first tunnel information comprises at least one of: a next-hop IP address and a destination IP address.

14. The SDNC of claim 11, wherein the one or more nodes have full mesh tunnel to other nodes in the SDNC.

15. An apparatus comprising:
a Software Defined Network controller (SDNC) configured to establish a relationship between a prefix of an IP address and tunnel information, to generate forwarding information based on the relationship, and to send forwarding information to one or more nodes so that the one or more nodes forward packet according to the forwarding information.
